(19) United States
(12) Patent Application Publication
(10) Pub. No.: US 2026/0114674 A1
(43) Pub. Date: Apr. 30, 2026

(54) Food Processor Extension and Pusher Assembly

(71) Applicant: Michael Scott Traudt, Bellingham, MA (US)

(72) Inventor: Michael Scott Traudt, Bellingham, MA (US)

(21) Appl. No.: 19/367,633

(22) Filed: Oct. 23, 2025

Related U.S. Application Data
(60) Provisional application No. 63/712,880, filed on Oct. 28, 2024.

(51) Int. Cl. A47J 43/07

(52) U.S. Cl. CPC A47J 43/075

(57) ABSTRACT

An improved food processor accessory is disclosed that enhances the efficiency, safety, and versatility of food preparation. The invention includes a large-diameter feed tube extension and a pusher assembly with pyramid-shaped protrusions for secure gripping and precise slicing. The blade is mounted at the top of the work bowl, and an exit hole allows processed food to spill out safely. Additional features include an integrated emergency switch rod, angled jacks for tilting the processor, and an optional wedge insert to prevent accumulation. The accessory significantly reduces processing time and offers a cost-effective alternative to industrial machines.

The current application claims a priority to the U.S. Provisional Patent application Ser. No. 63/712,880 filed on Oct. 28, 2024.

### FIELD OF THE INVENTION

The present invention relates generally to the field of food preparation and processing equipment. More specifically, it relates to an accessory or add-on for food processors that enhances their ability to handle larger food items, improves slicing precision, and increases overall processing efficiency and safety.

### BACKGROUND OF THE INVENTION

Food processors are widely used in both commercial and residential kitchens to automate tasks such as chopping, slicing, and shredding. While these machines offer convenience and speed, they often come with limitations in terms of feed tube size, slicing precision, and ease of cleaning. In particular, standard food processors struggle to accommodate large-diameter vegetables, which must be manually cut down to fit the feed tube, resulting in additional labor and time.

Existing solutions for high-volume food processing are typically expensive, bulky, and not tailored to the specific needs of small and medium-sized food businesses. Moreover, conventional pushers often fail to maintain perpendicular alignment between the food item and the blade, leading to uneven slicing and potential jamming. Safety is also a concern, as some designs expose users to the risk of accidental contact with the blade during operation or cleaning.

There is a need for a cost-effective, efficient, and safe solution that enhances the capabilities of existing food processors without requiring complete replacement or significant investment.

### SUMMARY OF THE INVENTION

The present invention provides an improved accessory for food processors that addresses the limitations of conventional designs. The invention includes a modified pusher assembly and feed tube extension that allow for the processing of larger vegetables with variable diameters. The pusher features pyramid-shaped protrusions that grip the food securely and maintain perpendicular alignment with the slicing blade, ensuring uniform cuts and preventing slippage.

The blade is mounted at the top of the work bowl, and a strategically placed exit hole allows sliced product to spill out efficiently while preventing user contact with the blade. The pusher assembly integrates an emergency switch rod to preserve the original safety features of the food processor. Additionally, the invention includes angled jacks that tilt the processor for improved product flow, and an optional wedge insert that prevents accumulation of sliced food in the bowl.

This add-on significantly reduces processing time and offers a safer, more efficient alternative to expensive industrial machines. For example, a bushel of cucumbers that would previously require 60 minutes of processing time could take 14 minutes with the present invention.

### BRIEF DESCRIPTION OF THE DRAWINGS

FIG. 1 shows a feed tube extension of the present invention.

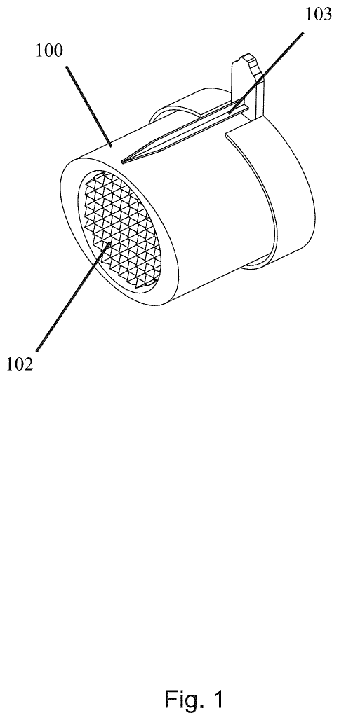

FIG. 2 shows the interior of the feed tube extension.

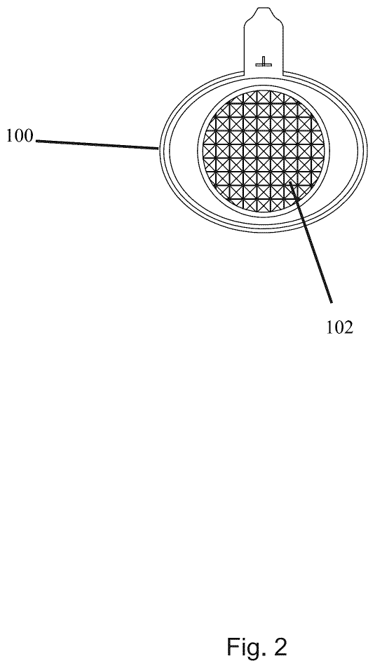

FIG. 3 shows another view of a feed tube extension of the present invention.

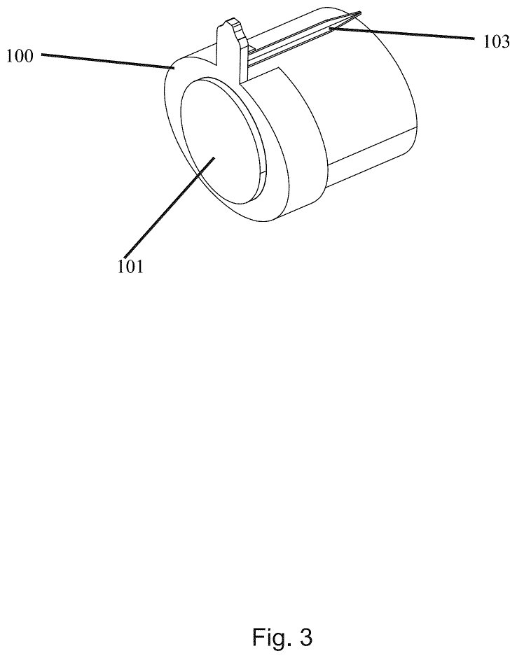

FIG. 4 shows presentation invention as used on a food processor.

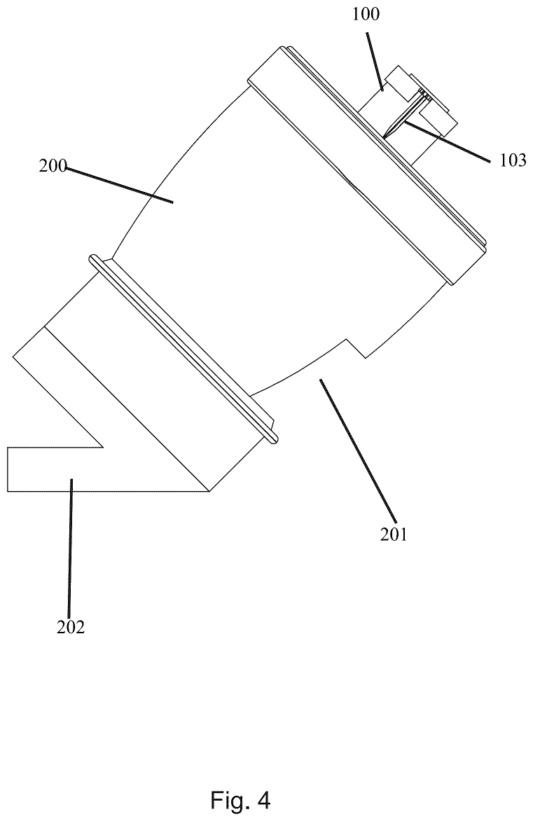

FIG. 5 shows another view of a food processor of the present invention.

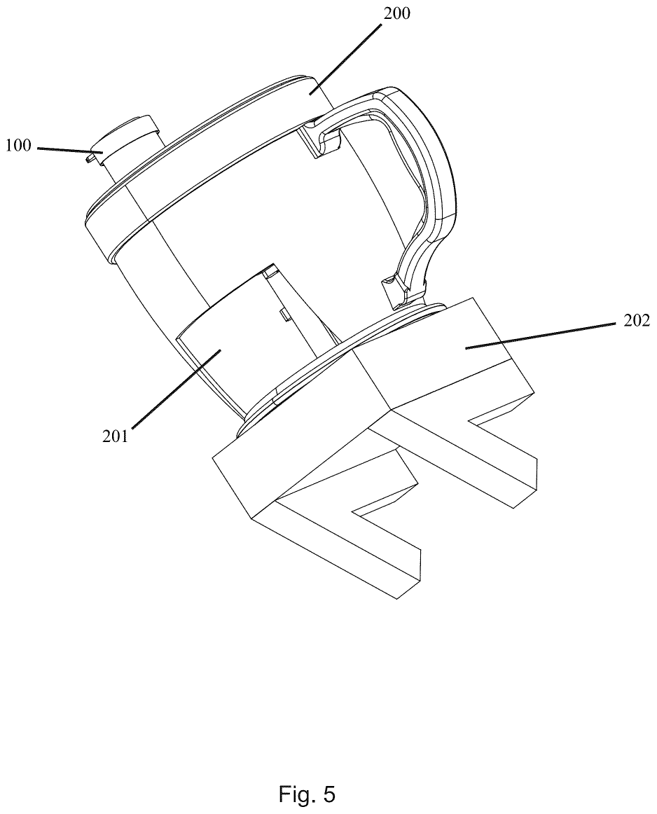

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of (invention name), embodiments of the present disclosure are not limited to use only in this context.

The present invention relates to an improved food processor accessory designed to enhance the efficiency, safety, and versatility of food preparation, particularly for businesses and individuals engaged in high-volume food processing. The invention comprises a set of modifications and add-ons to a standard food processor, such as those manufactured by Cuisinart, that significantly reduce processing time and accommodate larger food items that would otherwise be incompatible with conventional feeding tubes.

The invention enables a dramatic improvement in processing speed. This efficiency gain is achieved without the need for expensive industrial-grade equipment, making the invention a cost-effective solution for small to mid-sized food operations.

The present invention comprises a pusher assembly and feed tube extension (100) that allow for the continuous processing of vegetables with variable diameters, including those larger than the default feeding tube dimensions. The pusher assembly (101) may be 3D printed and features a diameter of approximately 2.5 inches, which is significantly larger than standard market offerings. This enlarged diameter accommodates bulkier produce and ensures a smoother feeding process. The diameter may vary depending on the needs of the user.

To address the challenge of maintaining perpendicular alignment between the food item and the slicing blade, the pusher is engineered with pyramid-shaped protrusions (102) on its contact surface. These pyramid points (102) grip the food securely and prevent slippage or rotation during processing, thereby ensuring uniform slicing and reducing the risk of jamming or uneven cuts.

The invention also includes a safety-conscious design that prevents user contact with the slicing blade. The blade is mounted at the top of the work bowl (200), and a strategically placed exit hole (201) in the working bin allows sliced product to spill out efficiently without requiring disassembly of the processor. This enhances safety and streamlines the workflow by enabling continuous operation and easy collection of processed food.

An additional feature of the invention is the integration of the emergency switch rod (103) into the pusher assembly, preserving the original safety mechanisms of the food processor. The mounting system includes a set of angled jacks (202) positioned at approximately 45 degrees on a support bucket that tilts the food processor. This angled orientation facilitates the natural flow of sliced product out of the processor and into a collection container.

Optionally, the invention may include a wedge-shaped insert that fits inside the work bowl. This insert spans from the far end of the bowl to the open edge and serves to prevent accumulation of processed food within the bowl, further enhancing the efficiency of the system.

In operation, the user inserts large vegetables into the modified feeder tube (100), positions the pusher to apply moderate pressure, and activates the processor (200) using the pulse function. The pusher (101) guides the food through the slicing mechanism while maintaining alignment, and the processed slices exit the bowl through the designated outlet (201). The entire process can be completed without disassembling the unit, allowing for rapid and hygienic food preparation.

Although the invention has been explained in relation to its preferred embodiment, it is to be understood that many other possible modifications and variations can be made without departing from the spirit and scope of the invention.

What is claimed is:

1. A food processor accessory comprising,
a feed tube extension, said feed tube extension comprising pyramid-shaped protrusions on its contact surface;
a pusher assembly; and
an emergency switch rod within the pusher assembly.

2. The food processor accessory of claim 1, wherein the food processor accessory is mounted to the top of a food processor, and the food processor further comprises an exit hole through which the processed food can safely exit the processor.

3. The food processor accessory of claim 1, further comprising a set of angled jacks to which the food processor is mounted, said jacks angled at approximately 45 degrees.

4. The food processor accessory of claim 1, further comprising a wedge-shaped insert positioned within the work bowl to prevent accumulation of sliced food.

5. A method of processing food, wherein food is inserted into the feed tube extension, positioning the pusher, activating the slicer of the food processor, and collecting the sliced food through an exit hole in the side of the food processor.

6. The food processor accessory of claim 1, wherein the feed tube extension and pusher assembly are 3D printed.

7. A food processor accessory comprising,
a feed tube extension, said feed tube extension comprising pyramid-shaped protrusions on its contact surface;
a pusher assembly; and
an emergency switch rod within the pusher assembly; and
a food processor, wherein the feed tube extension and pusher assembly mounted to the top food processor, and
the food processor further comprising an exit hole.
